(19) United States
(12) Patent Application Publication
(10) Pub. No.: US 2002/0102436 A1
(43) Pub. Date: Aug. 1, 2002

(54) Tunnel magnetoresistive element and magnetic head incorporating the same

(76) Inventor: Yasuhiko Shinjo, Kanagawa (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/055,955

(22) Filed: Jan. 28, 2002

(30) Foreign Application Priority Data
Jan. 31, 2001 (JP) P.2001-22692

(51) Int. Cl. G11B 5/127

(52) U.S. Cl. 428/692

(57) ABSTRACT

In a tunnel magnetoresistive element, a free layer whose magnetized direction is changed according to an external magnetic field is formed on a first insulative layer. A second insulative layer, through which a tunnel current flows, is formed on the free layer. A pin layer whose magnetized direction is substantially unchanged according to the external magnetic field is formed on the second insulative layer. The free layer and the pin layer respectively have lead-out portions on which electrodes for providing the tunnel current are formed. The lead-out portions extend such that the electrodes are not exposed on a surface facing a magnetic recording medium.

### BACKGROUND OF THE INVENTION

The present invention relates to a tunnel magnetoresistive element in which a free layer, whose magnetized direction is changed according to an external magnetic field, and a pin layer, whose magnetized direction is unchanged, are laminated through an insulative layer, and to a magnetic head incorporating this tunnel magnetoresistive element.

A magnetic head having a tunnel magnetoresistive element is known as a magnetic device for detecting an external magnetic field, such as a signal magnetic field generated from a magnetic recording medium. In a magnetic head using this tunnel magnetoresistive element, the magnetized direction of a free layer is changed owing to the influence of a signal magnetic field. The magnitude of a tunnel current flowing between both layers depending upon a relative angle, which the magnetized direction of the free layer forms with that of the pin layer, changes and indicates a change in resistance. Therefore, to detect the signal magnetic field generated from the magnetic recording medium, a change in the tunnel current flowing between the free layer and the pin layer or a change in the resistance therebetween is detected.

FIG. 12 illustrates the structure of a related tunnel magnetoresistive element. This tunnel magnetoresistive element has a free layer 100, whose magnetized direction is changed according to an external magnetic field, and a pin layer 101, whose magnetized direction is unchanged even when the external magnetic field is applied thereto, and an anti-ferromagnetic film 102 serving to fix the magnetization of the pin layer 101 are laminated so as to sandwich an insulative layer 103 therebetween. The tunnel magnetoresistive element has electrodes 104 respectively connected to the free layer 100 and the pin layer 101 so as to conduct a tunnel current between the free layer 100 and the pin layer 101 through the insulative layer 103. These electrodes 104 are laminated on the free layer 100 and the pin layer 101, respectively, and connected to a power supply (not shown).

Further, the magnetic head provided with this tunnel magnetic head has a pair of upper and lower shield magnetic layers 105 disposed in such a way as to sandwich the tunnel magnetoresistive element therebetween. The pair of the upper and lower shield magnetic layers 105 are respectively used for drawing-in a signal magnetic field other than a signal magnetic field to be reproduced, and for applying to the tunnel magnetoresistive element only the signal magnetic field to be reproduced.

In such a magnetic head, the tunnel magnetoresistive element is formed by forming the electrode 104, the free layer 100, the insulative layer 103, the pin layer 101, the anti-ferromagnetic film 102, the electrode 104, and the upper shield magnetic layer 105 in this order on the lower shield magnetic layer 105.

Meanwhile, in the magnetic tunnel element, the insulative layer 103 should be formed in such a manner as to have a uniform thickness so as to reliably let a tunnel current flow therethrough. When the insulative layer 103 cannot be formed in such a way as to have a uniform thickness, a leak occurs in a micro region between the pin layer 100 and the free layer 101, so that no tunnel current cannot be reliably let flow therethrough. When a leak occurs in the micro region, the leak becomes a cause of noises to the magnetic head. Thus, the reproducing characteristics thereof are deteriorated.

### SUMMARY OF THE INVENTION

It is therefore an object of the invention is to provide a magnetic tunnel element that has an insulative layer formed in such a way as to have a uniform thickness thereby to reliably prevent an occurrence of a leak between a free layer and a pin layer, and to provide a magnetic head that incorporates this magnetic tunnel element so that excellent reproducing characteristics is exhibited.

In order to achieve the above object, according to the present invention, there is provided a tunnel magnetoresistive element, comprising:

a first insulative layer;

a free layer formed on the first insulative layer, whose magnetized direction is changed according to an external magnetic field;

a second insulative layer formed on the free layer, through which a tunnel current flows; and

a pin layer formed on the second insulative layer, whose magnetized direction is substantially unchanged according to the external magnetic field.

The problem explained with reference to the related art is arisen due to the fact that the insulative layer interposed between the free layer and the pin layer is affected by the surface state of the electrode placed thereunder.

However, according to the above configuration, since a surface of the first insulative layer is smoother than that of electrode, the surface state of the first insulative layer seldom affects the respective layers laminated on the first insulative layer. Therefore, each of the free layer, the second insulative layer and the pin layer can be formed in such a manner as to uniformly have a predetermined thickness. Further, the generation of a pin hole can be restrained in such a way as to be performed within the film of the second insulative layer. Thus, an occurrence of a leak between the free layer and the pin layer can be prevented. Consequently, a tunnel current can be reliably let flow therebetween.

Preferably, the free layer and the pin layer respectively have lead-out portions on which electrodes for providing the tunnel current are formed. Here, the lead-out portions extend such that the electrodes are not exposed on a surface facing a magnetic recording medium.

In this configuration, the reproducing gap length can be reduced. Consequently, the signal magnetic field recorded at a high density on the magnetic recording medium can be reliably reproduced.

Preferably, the pin layer includes a magnetic layer formed on the second insulative layer and an anti-ferromagnetic layer formed on the magnetic layer for fixing a magnetized direction of the magnetic layer.

Preferably, the tunnel magnetoresistive element further comprises a pair of shield magnetic layers which sandwich the first insulative layer, the free layer, the second insulative layer and the pin layer therebetween.

According to the present invention, there is also provided a method of manufacturing a tunnel magnetoresistive element, comprising the steps of:

providing a first insulative layer;

forming a free layer made of a material whose magnetized direction is changed according to an external magnetic field, on the first insulative layer;

forming a second insulative layer on the free layer; and

forming a pin layer whose magnetized direction is substantially unchanged according to the external magnetic field, on the second insulative layer.

Preferably, the free layer forming step includes a step of forming a first lead-out portion on which a first electrode is formed, and the pin layer forming step includes a step of forming a second lead-out portion on which a second electrode is formed. Here, the first lead-out portion and the second lead-out portion are respectively extended from the free layer and the pin layer such that the first electrode and the second electrode are not exposed on a surface of the tunnel magnetoresistive element which faces a magnetic recording medium.

In the above configurations, the same advantages as explained the above can be attained.

According to the present invention, there is also provided a magnetic head incorporating the above tunnel magnetoresistive element.

In this configuration, since a tunnel current can be reliably flown in the tunnel magnetoresistive element, excellent reproducing characteristics can be attained.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a sectional view illustrating a primary part of a magnetic head according to one embodiment of the invention;

FIG. 2 is a plan view illustrating a primary part of a tunnel magnetoresistive element of the magnetic head;

FIGS. 3 to 11 are perspective views illustrating the process of manufacturing the magnetic head; and

FIG. 12 is a sectional view illustrating a primary part of a related magnetic head element.

### DETAILED DESCRIPTION OF THE PREFERRED EMBODIMENTS

Hereinafter, a tunnel magnetoresistive element and a magnetic head incorporating the same according to one preferred embodiment of the invention will be described with reference to the accompanying drawings.

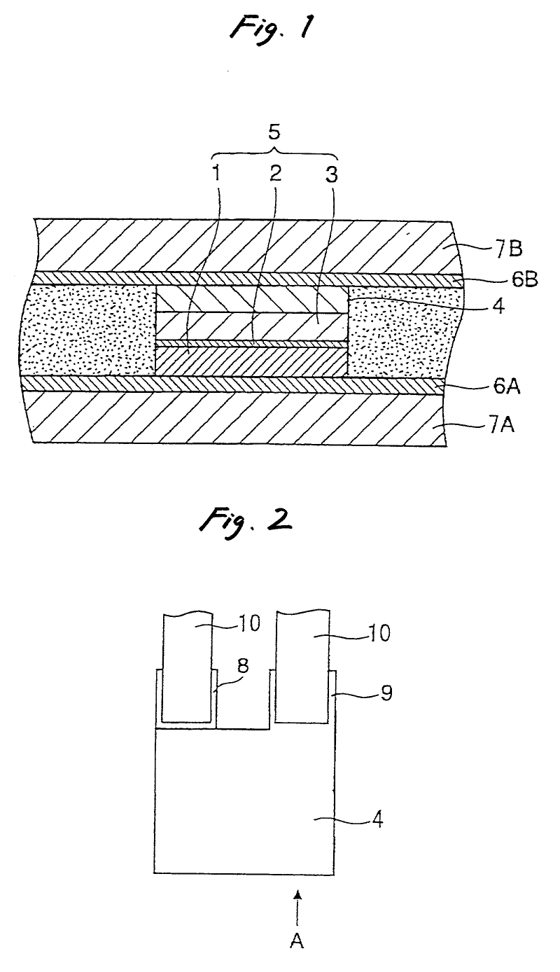

FIG. 1 shows a sectional view of a magnetic head, to which the invention is applied, at the side of a surface thereof, which faces a magnetic recording medium. As shown in this figure, the magnetic head is provided with a tunnel magnetoresistive element 5 that has a free layer 1, whose magnetized direction is changed according to a signal magnetic field generated from the magnetic recording medium, an insulative layer 2, which is formed on this free layer 1, and a pin layer 3 disposed in such a manner as to face the free layer 1 through the insulative layer 2, so that the magnetized direction thereof is substantially unchanged in response to the signal magnetic field. Incidentally, the anti-ferromagnetic film 4 serves to fix the magnetization of the pin layer 3.

The magnetic head has a pair of shield magnetic layers 7A and 7B that sandwich a magnetoresistive element 5 and an anti-ferromagnetic film 4 through insulative films 6A and 66 constituted by Al₂O₃ films. The free layer 1 is constituted by, for instance, a NiFe film and a CoFe film. The insulative layer 2 is constituted by, for example, an Al₂O₃ film. The pin layer 3 is constituted by, for instance, a NiFe film. The anti-ferromagnetic film 4 is constituted by, for instance, a NiMn film.

Further, in this magnetic head, a first lead-out portion 8, which is obtained by drawing out a part of the free layer 1 to a side surface opposite to a surface A facing a magnetic recording medium, and a second lead-out portion 9, which is obtained by drawing out a part of the anti-ferromagnetic film 4 to a side surface opposite to the surface A facing the magnetic recording medium, are formed in the tunnel magnetoresistive element 5, as schematically illustrated in FIG. 2. This magnetic head has electrodes 10 respectively connected to the first lead-out portion 8 and the second lead-out portion 9. These electrodes 10 are connected to a power supply (not shown). Thus, a tunnel current can be let flow between the free layer 1 and the pin layer 3 through the insulative layer 2.

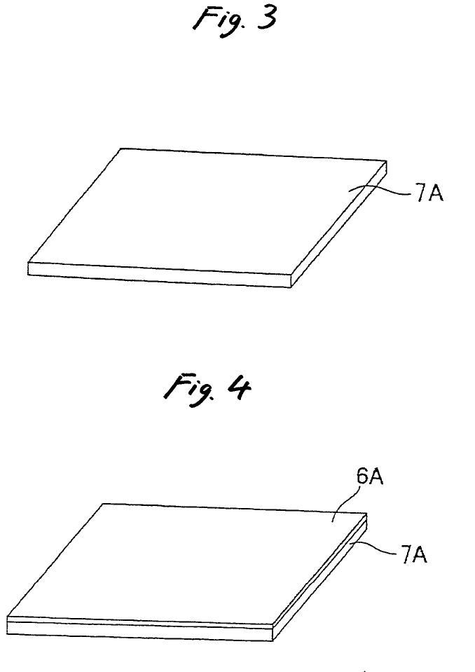

Meanwhile, when this magnetic head is manufactured, first, the lower shield layer 7A is formed on a nonmagnetic substrate (not shown), as illustrated in FIG. 3. This shield magnetic layer 7A can be formed by electroplating so that the thickness of, for example, the NiFe film is about 2 μm.

Subsequently, as illustrated in FIG. 4, the insulative film 6A is formed on the shield magnetic layer 7A by a sputtering apparatus so that the thickness of the film 6A is about 500 Å. This insulative film 6A can provide magnetic shielding between the free layer 1 and the shield magnetic layer 7A formed on this insulative film 6A. For example, an Al₂O₃ film may be cited as the insulative film 6A.

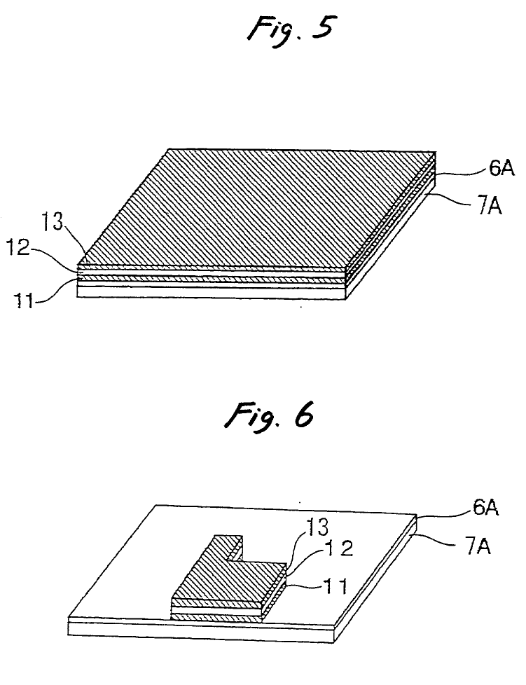

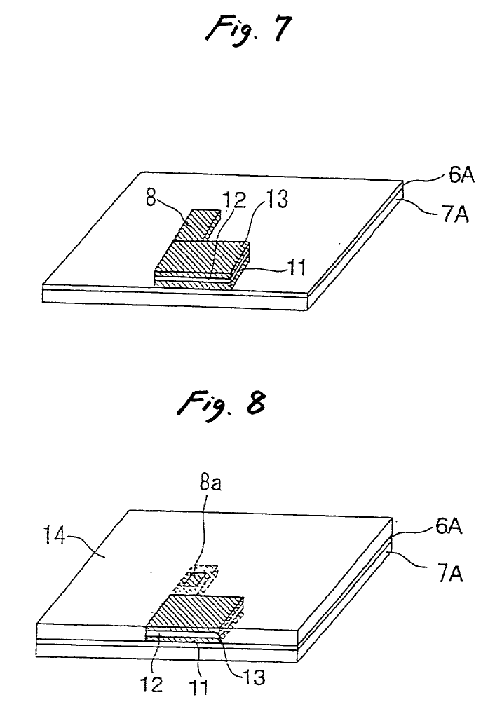

Then, as illustrated in FIGS. 5 to 11, a tunnel magnetoresistive element 5 is manufactured on the insulative film 6A. That is, as illustrated in FIG. 5, for instance, a magnetic film 11 serving as the free layer 1, which is constituted by a NiFe film and a CoFe film, is formed by the sputtering apparatus on the insulative film 6A. For example, an Al₂O₃ film serving as the insulative layer 2 is formed by the sputtering apparatus through plasma oxidation after an Al film is formed. In the pin layer 3, for instance, a NiFe film 13 is formed by the sputtering apparatus. Thus, the thicknesses of these layers are set at, for instance, 50 Å, 7 Å, and 30 Å, respectively. Subsequently, as illustrated in FIG. 6, a laminated product formed on the insulative film 6A is processed through an etching process using film (not shown) in such a way as to be substantially L-shaped. Subsequently, as illustrated in FIG. 7, each of the Al₂O₃ film and the NiFe film 13 of the pin layer 3 other than the free layer 1 is processed through an etching process using a resist film (not shown) in such a manner as to be substantially rectangle. Thus, the first lead-out portion 8 to be obtained by drawing out a part only of the free layer 1 to a side surface opposite to the surface A facing the magnetic recording medium is formed. Moreover, the nearly rectangular shaped Al₂O₃ film 12 and NiFe film 13 of the pin layer 3 are formed on the nearly-L-shaped free layer 1.

Then, as illustrated in FIG. 8, an insulative layer 14 constituted by, for instance, an Al₂O₃ film is formed. Subsequently, only a principal plane of the NiFe film 12 of the pin layer 3 is outwardly exposed by lift-off techniques. Further, a contact portion 8a is formed on the first lead-out portion 8. Then, as illustrated in FIG. 9, after an anti-ferromagnetic film 15 is formed on each of the insulative layer 14 and the NiFe film 12 of the pin layer 3, this anti-ferromagnetic film 15 is processed through an etching process using a resist film in such a manner as to be substantially L-shaped so as to extend in an orientation opposite to the L-shape of the free layer 1 extends, so that the film 15 is prevented from overlapping with the free layer 1. Thus, the second lead-out portion 9 to be obtained by drawing out a part of the anti-ferromagnetic film 4 to a side surface opposite to the surface A facing the magnetic recording medium is formed.

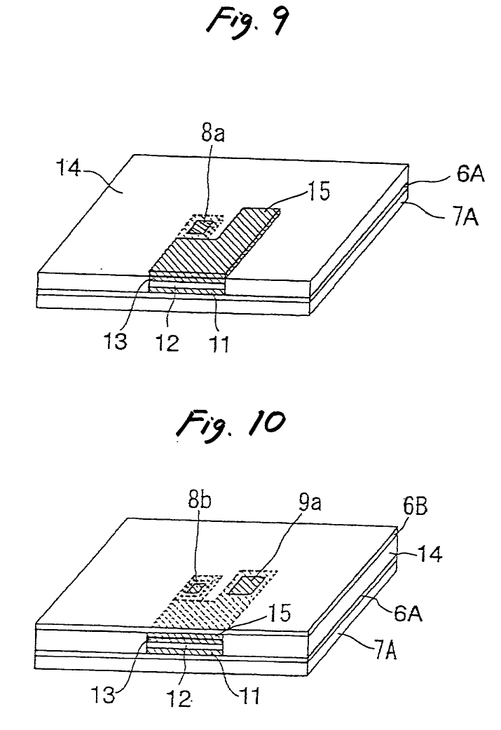

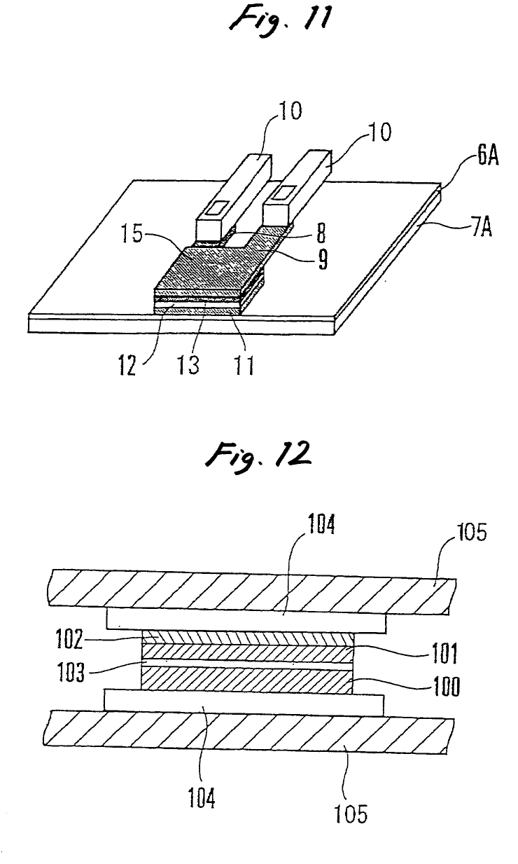

Then, as illustrated in FIG. 10, the insulative layer 6B constituted by, for instance, an Al₂O₃ film is formed. Further, contact portions 8b and 9a are formed on the contact portion 8a and the second lead-out portion 9 by the lift-off techniques, respectively. Subsequently, as illustrated in FIG. 11, thereafter, the electrodes 10 each constituted by an Au film (whose film thickness is 1500 Å) are formed respectively corresponding to the first lead-out portion 8 of the free layer 1 and the second lead-out portion 9. Incidentally, FIG. 11 is drawn by omitting insulative materials.

Furthermore, the upper shield magnetic layer 7B is formed on the magnetic tunnel element through the insulative film 6B. Consequently, the magnetic head is completed.

The magnetic head manufactured in the aforementioned way can detect a signal magnetic field generated from the magnetic recording medium. That is, in the magnetic head, the magnetized direction of the free layer 1 affected by the signal magnetic field changes. The magnitude of a tunnel current flowing between both the layers 1 and 3 changes depending upon a relative angle which the magnetized direction of the free layer 1 with that of the pin layer 3, and is indicated as a change in resistance. Therefore, it is be sufficient for detecting the signal magnetic field generated from the magnetic recording medium to detect a change in value of resistance of a path for a tunnel current flowing through the free layer 1 and the pin layer 3.

In this magnetic head, the free layer 1 is formed on the insulative film 6A, and not formed on the electrode as in the related magnetic head. Therefore, as described above, when the free layer 1, the insulative layer 2, and the pin layer 3 are formed, these layers are to be affected by the surface state of the insulative film 6A. However, the surface of the insulative film 6A is a smooth one, as compared with that of the electrode 10. Thus, the surface state of the insulative film 6A seldom affects such layers. Consequently, the free layer 1, the insulative layer 2, and the pin layer 3 can be uniformly formed. Furthermore, a pin hole can be restrained from being generated in the film of the insulative layer 2. Moreover, a leak between the free layer 1 and the pin layer 3 can be prevented from locally occurring.

Further, this magnetic head is configured so that the electrode 10 is not exposed to the surface facing a magnetic recording medium. Thus, the distance between the pair of upper and lower shield magnetic layers 7A and 7B, that is, a reproducing gap length thereof can be made to be small. Consequently, this magnetic head can reliably reproduce a signal magnetic field recorded at a high density on a magnetic recording medium.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A tunnel magnetoresistive element, comprising:
a first insulative layer;
a free layer formed on the first insulative layer, whose magnetized direction is changed according to an external magnetic field;
a second insulative layer formed on the free layer, through which a tunnel current flows; and
a pin layer formed on the second insulative layer, whose magnetized direction is substantially unchanged according to the external magnetic field.

2. The tunnel magnetoresistive element as set forth in claim 1, wherein:
the free layer and the pin layer respectively have lead-out portions on which electrodes for providing the tunnel current are formed; and
the lead-out portions extend such that the electrodes are not exposed on a surface facing a magnetic recording medium.

3. The tunnel magnetoresistive element as set forth in claim 1, wherein the pin layer includes a magnetic layer formed on the second insulative layer and an anti-ferromagnetic layer formed on the magnetic layer for fixing a magnetized direction of the magnetic layer.

4. The tunnel magnetoresistive element as set forth in claim 1, further comprising a pair of shield magnetic layers which sandwich the first insulative layer, the free layer, the second insulative layer and the pin layer therebetween.

5. A magnetic head incorporating the tunnel magnetoresistive element as set forth in claim 1.

6. A method of manufacturing a tunnel magnetoresistive element, comprising the steps of:
providing a first insulative layer;
forming a free layer made of a material whose magnetized direction is changed according to an external magnetic field, on the first insulative layer;
forming a second insulative layer on the free layer; and
forming a pin layer whose magnetized direction is substantially unchanged according to the external magnetic field, on the second insulative layer.

7. The manufacturing method as set forth in claim 6, wherein:
the free layer forming step includes a step of forming a first lead-out portion on which a first electrode is formed;
the pin layer forming step includes a step of forming a second lead-out portion on which a second electrode is formed; and
the first lead-out portion and the second lead-out portion are respectively extended from the free layer and the pin layer such that the first electrode and the second electrode are not exposed on a surface of the tunnel magnetoresistive element which faces a magnetic recording medium.
